(19) United States
(12) Patent Application Publication
(10) Pub. No.: US 2026/0046674 A1
(43) Pub. Date: Feb. 12, 2026

(54) METHOD AND DEVICE FOR REPORTING MULTIPLE PIECES OF DELAY STATUS INFORMATION IN WIRELESS COMMUNICATION SYSTEM

(71) Applicant: Samsung Electronics Co., Ltd., Suwon-si (KR)

(72) Inventors: Weiping SUN, Suwon-si (KR); Hyunjeong KANG, Suwon-si (KR)

(21) Appl. No.: 19/294,896

(22) Filed: Aug. 8, 2025

(30) Foreign Application Priority Data
Aug. 8, 2024 (KR) 10-2024-0106375

(51) Int. Cl. H04W 28/02; H04L 5/00; H04W 80/02

(52) U.S. Cl. CPC H04W 28/0236; H04L 5/0044; H04L 5/0053; H04W 80/02

(57) ABSTRACT

The disclosure relates to a 5G or 6G communication system for supporting a higher data transmission rate. A method performed by a terminal in a wireless communication system is provided. The method includes transmitting, to a base station, first information indicating that the terminal supports a delay status report (DSR) of a buffered data, receiving, from the base station, configuration information on a plurality of remaining time thresholds per logical channel group (LCG), and transmitting, to the base station, second information including a remaining time field indicating the shortest remaining time among packet data convergence protocol (PDCP) service data units (SDUs) associated with a corresponding remaining time threshold of an LCG.

### CROSS-REFERENCE TO RELATED APPLICATION(S)

This application is based on and claims priority under 35 U.S. C. § 119(a) of a Korean patent application number 10-2024-0106375, filed on Aug. 8, 2024, in the Korean Intellectual Property Office, the disclosure of which is incorporated by reference herein in its entirety.

### BACKGROUND

### 1. Field

The disclosure relates to a wireless communication system. More particularly, the disclosure relates to a method and a device for reporting multiple pieces of delay status information in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a device for reporting multiple delay statuses in a wireless communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes transmitting, to a base station, first information indicating that the terminal supports a delay status report (DSR) of a buffered data, receiving, from the base station, configuration information on a plurality of remaining time thresholds per logical channel group (LCG), and transmitting, to the base station, second information including a remaining time field indicating the shortest remaining time among packet data convergence protocol (PDCP) service data units (SDUs) associated with a corresponding remaining time threshold of an LCG.

In accordance with another aspect of the disclosure, a method performed by a base station in a wireless communication system is provided. The method includes receiving, from a terminal, first information indicating that the terminal supports a delay status report (DSR) of a buffered data, transmitting, to the terminal, configuration information on a plurality of remaining time thresholds per logical channel group (LCG), and receiving, from a terminal, second information including a remaining time field indicating the shortest remaining time among packet data convergence protocol (PDCP) service data units (SDUs) associated with a corresponding remaining time threshold of an LCG.

In accordance with another aspect of the disclosure, a terminal is provided. The terminal includes at least one transceiver, at least one processor communicatively coupled to the at least one transceiver, and at least one memory, communicatively coupled to the at least one processor, storing instructions executable by the at least one processor individually or in any combination to cause the terminal to transmit, to a base station, first information indicating that the terminal supports a delay status report (DSR) of a buffered data, receive, from the base station, configuration information on a plurality of remaining time thresholds per logical channel group (LCG), and transmit, to the base station, second information including a remaining time field indicating the shortest remaining time among packet data convergence protocol (PDCP) service data units (SDUs) associated with a corresponding remaining time threshold of an LCG.

In accordance with another aspect of the disclosure, a base station is provided. The base station includes at least one transceiver, at least one processor communicatively coupled to the at least one transceiver, and at least one memory, communicatively coupled to the at least one processor, storing instructions executable by the at least one processor individually or in any combination to cause the base station to receive, from a terminal, first information indicating that the terminal supports a delay status report (DSR) of a buffered data, transmit, to the terminal, configuration information on a plurality of remaining time thresholds per logical channel group (LCG), and receive, from a terminal, second information including a remaining time field indicating the shortest remaining time among packet data convergence protocol (PDCP) service data units (SDUs) associated with a corresponding remaining time threshold of an LCG.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system according to an embodiment of the disclosure;

FIG. 2 illustrates a wireless protocol structure in a wireless communication system according to an embodiment of the disclosure;

FIG. 3 illustrates a procedure for establishing a connection with a network by a UE in a wireless communication system according to an embodiment of the disclosure;

FIG. 4 illustrates a dynamic scheduling request (DSR) medium access control (MAC) control element (CE) format in a wireless communication system according to an embodiment of the disclosure;

FIG. 5 illustrates an operation in which a terminal reports a delay status through an Extended/Refined/Enhanced/Multi-Pair DSR in a wireless communication system according to an embodiment of the disclosure;

FIG. 6 illustrates an Extended/Refined/Enhanced/Multi-Pair DSR MAC CE format in a wireless communication system according to an embodiment of the disclosure;

FIG. 7 illustrates a configuration of a terminal in a wireless communication system according to an embodiment of the disclosure; and

FIG. 8 illustrates a configuration of a base station in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to frequency division duplex (FDD) and time division duplex (TDD) systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit. ” Moreover, the elements and “units” may be implemented to reproduce one or more central processing units (CPUs) within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

A wireless communication system is advancing to a broadband wireless communication system for providing high-speed and high-quality packet data services using communication standards, such as high-speed packet access (HSPA) of third generation partnership project (3GPP), LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), Institute of Electrical and Electronics Engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

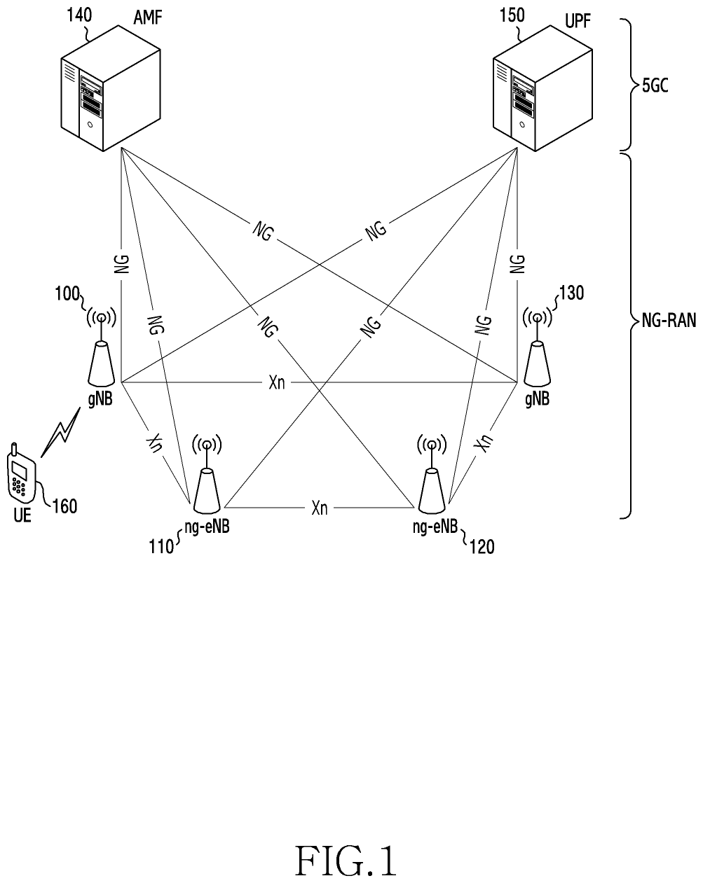

FIG. 1 illustrates a structure of a wireless communication system according to an embodiment of the disclosure. More specifically, referring to FIG. 1, a structure of an NR system is illustrated.

Referring to FIG. 1, a wireless communication system may include multiple base stations (e.g., a next generation node b (gNB) 100, a next generation evolved node B (ng-eNB) 110, an ng-eNB 120, and a gNB 130), an access and mobility management function (AMF) 140, and a user plane function (UPF) 150. The wireless communication system is not limited to the configuration illustrated in FIG. 1, and may include more or fewer components.

According to an embodiment of the disclosure, a user equipment (hereinafter, referred to as a UE or a terminal) 160 may access an external network through at least one of the base stations 100, 110, 120, and 130 or the UPF 150.

In FIG. 1, the base stations 100, 110, 120, and 130 may serve as access nodes of a cellular network and provide wireless access to UEs which access the network. For example, in order to serve traffic of users, the base stations 100, 110, 120, and 130 may collect at least one piece of status information such as a buffer status, an available transmission power status, or a channel status of the UEs, and perform scheduling. The base stations may support a connection between the UEs and a core network (CN). The CN of NR may refer to a 5th generation core network (5GC).

The gNBs 100 and 130 may control multiple cells. The gNBs 100 and 130 may apply an adaptive modulation and coding (AMC) scheme for determining a modulation scheme and a channel coding rate according to a channel status of a UE.

The core network may be a device responsible for various control functions as well as a mobility management function for the UE. The core network may be connected to the multiple base stations. In addition, 5GC may be linked with the existing LTE system.

In the wireless communication system, a user plane (hereinafter, referred to as a UP) related to transmission of actual user data and a control plane (hereinafter, referred to as a CP) such as connection management may be configured separately. The gNB 100 and the gNB 130 may use UP and CP technologies defined in NR technology. The ng-eNB 110 and the ng-eNB 120 may use UP and CP technologies defined in LTE technology.

The AMF 140 may perform a mobility management function for the UE. The AMF 140 is a device responsible for a control function and may be connected to the multiple base stations.

The UPF 150 may refer to a gateway device that provides data transmission. An NR wireless communication system may include a session management function (SMF). The SMF may manage a packet data network connection such as a protocol data unit (PDU) session provided to the UE.

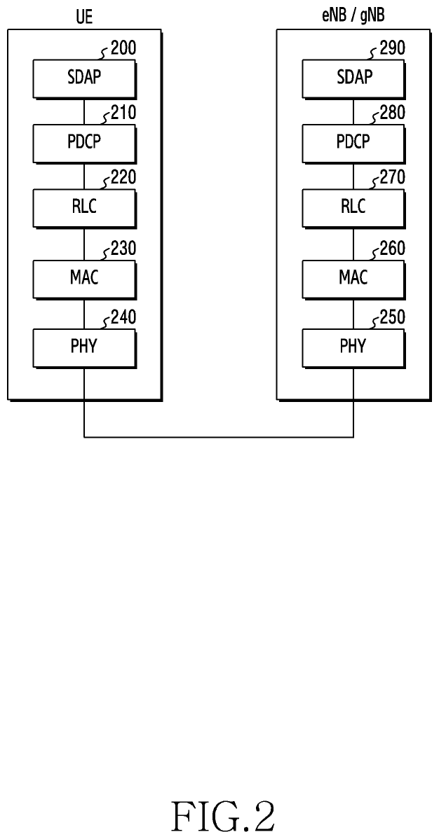

FIG. 2 illustrates a wireless protocol structure in a wireless communication system according to an embodiment of the disclosure. More specifically, referring to FIG. 2, a wireless protocol structure in an NR system is illustrated.

Referring to FIG. 2, a wireless protocol of the NR system may include at least one of a service data adaptation protocol (SDAP) 200, a packet data convergence protocol (PDCP) 210, radio link control (RLC) 220, medium access control (MAC) 230, or physical (PHY) 240 at a UE.

The wireless protocol of the NR system may include at least one of an SDAP 290, a PDCP 280, RLC 270, MAC 260, or PHY 250 at a base station.

In the following, the terms “SDAP, PDCP, RLC, MAC, PHY, and RRC” may be used interchangeably with an SDAP layer, a PDCP layer, an RLC layer, a MAC layer, a PHY layer, and an RRC layer, respectively, and have the same meaning.

The SDAP 200 or 290 layer may deliver user data. The SDAP 200 or 290 may perform at least one of operations of: mapping a quality of service (QoS) flow to a specific data radio bearer (DRB) for uplink and downlink, marking a QoS flow identifier (ID) for uplink and downlink, or mapping a reflective QoS flow to a data bearer for uplink SDAP protocol data units (PDUs). An SDAP configuration corresponding to each DRB may be provided from an upper RRC layer. However, this is only an embodiment, and an operation or a function of the SDAP is not limited to the above example.

The PDCP 210 or 280 layer may perform compression and/or decompression of an Internet protocol (IP) header. In addition, the PDCP 210 or 280 may provide at least one of the following functions: in-sequence and/or out-of-sequence delivery, sequence reordering, duplicate detection, retransmission, encryption, or decryption. However, this is only an embodiment, and an operation or a function of the PDCP is not limited to the above example.

The RLC 220 or 270 may reassemble a PDCP PDU into an appropriate size. The RLC 220 or 270 may provide at least one of the following functions: in-sequence and/or out-of-sequence delivery, automatic repeat request (ARQ), concatenation, segmentation, reassembly, re-segmentation, sequence reordering, duplicate detection, or error detection. However, this is only an embodiment, and an operation or a function of the RLC is not limited to the above example.

The MAC 230 or 260 may be connected to multiple RLC layer devices configured in one device. The MAC 230 or 260 may perform at least one of an operation of multiplexing RLC PDUs into a MAC PDU or an operation of demultiplexing RLC PDUs from a MAC PDU. The MAC may provide at least one of a mapping function, a scheduling information reporting function, a hybrid automatic repeat request (HARQ) function, a function of adjusting priority among logical channels, a function of adjusting priority among UEs, a multimedia broadcast and multicast service (MBMS) service identification function, a transmission format selection function, or a padding function. However, this is only an embodiment, and an operation or a function of the MAC is not limited to the above example.

The PHY 240 or 250 may generate an orthogonal frequency division multiplexing (OFDM) symbol by performing channel coding and modulation on upper layer data, and transmit the OFDM symbol through a wireless channel. The PHY 240 or 250 may demodulate the OFDM symbol received through the wireless channel, perform channel decoding, and transmit the decoded data to an upper layer. In the PHY layer, an HARQ may be used for additional error correction. A reception end may transmit whether a packet transmitted by a transmission end is received by using one bit. The 1-bit information may correspond to HARQ acknowledgement (ACK) or negative acknowledgement (NACK) information.

In the case of LTE, downlink HARQ ACK or NACK information for uplink data transmission may be transmitted through a physical hybrid-ARQ indicator channel (PHICH) physical channel. In the case of NR, whether retransmission is required or whether new transmission is performed may be determined via scheduling information of a UE through a physical downlink control channel (PDCCH), which is a channel through which downlink or uplink resource allocation is transmitted. This is because asynchronous HARQ may be applied in NR.

Uplink HARQ ACK or NACK information for downlink data transmission may be transmitted through a physical uplink control channel (PUCCH) or a physical uplink shared channel (PUSCH) physical channel. The PUCCH may be transmitted in an uplink of a primary cell (PCell). If supported by the UE, the PUCCH may be transmitted in a secondary cell (SCell). For example, if supported by the UE, the PUCCH may be transmitted from the UE to the base station on an uplink of the SCell. Here, the SCell may refer to a PUCCH SCell.

An RRC layer may exist above a PDCP layer of the UE and the base station. The RRC layer may transmit and/or receive an access and/or measurement-related configuration control message for radio resource control.

A physical layer may include at least one of at least one frequency or carrier. A technology of simultaneously configuring and using multiple frequencies may refer to a carrier aggregation (CA) technology. One carrier may be used for communication between a UE and a base station (eNB or gNB). When the CA technology is used, a primary carrier and at least one secondary carrier may be used for communication between the UE and the base station. In this case, the amount of data transmission may increase according to the increased number of secondary carriers. A cell within a base station using a primary carrier in LTE or NR may refer to a primary cell or PCell. A cell within a base station using a secondary cell in LTE or NR may refer to a secondary cell or SCell. In an embodiment of the disclosure, an entity may be referred to as a layer device, and the terms may have the same meaning.

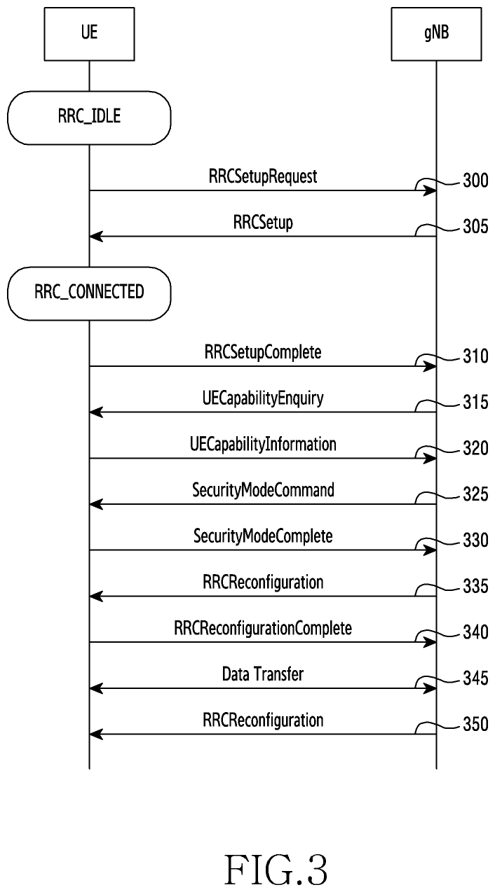

FIG. 3 illustrates a procedure for establishing an RRC connection with a base station by a UE in a wireless communication system according to an embodiment of the disclosure.

Referring to FIG. 3, in the disclosure, a UE may transition from an RRC idle mode (RRC_IDLE) to an RRC connected mode (RRC_CONNECTED) to establish a connection with a network. The UE may establish uplink or downlink transmission synchronization with a base station through a random access process.

The UE may transmit an RRCSetupRequest message to the base station (operation 300). The RRCSetupRequest message may include at least one of a UE identifier or a reason for establishing a connection (e.g., EstablishmentCause).

The base station may transmit an RRCSetup message to the UE so that the UE may establish an RRC connection (operation 305). For example, the RRCSetup message may include, for each cell group (e.g., at least one of a master cell group (MCG) or a secondary cell group (SCG)), MAC layer device configuration information (e.g., MAC-CellGroupConfig) belonging to a corresponding cell group. For example, the RRCSetup message may include, for each cell group (e.g., at least one of an MCG or an SCG), configuration information (e.g., ServingCellConfig) of a serving cell (which may be an SpCell or an SCell) belonging to a corresponding cell group.

The UE having established the RRC connection may enter an RRC_CONNECTED mode. The UE may transmit an RRCSetupComplete message to the base station (operation 310).

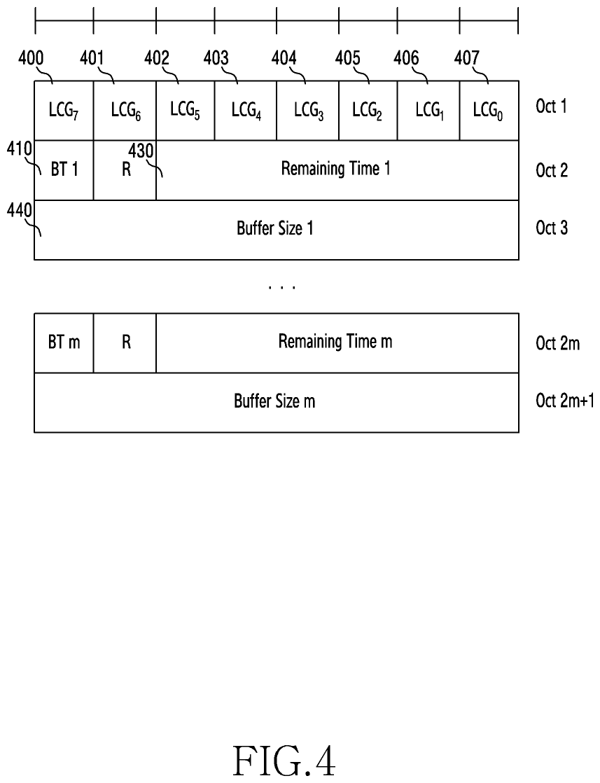

When the base station is unaware of the capability of the UE that is currently establishing a connection or when it intends to identify the capability of the UE, the base station may transmit, to the UE, a message (e.g., UECapabilityInquiry) inquiring about the capability of the UE (operation 315). The base station may include a request for UE capability for each RAT type in the UECapabilityInquiry message. For example, the base station may include filtering information capable of indicating a condition and a restriction when requesting the UE to generate a UECapabilityInformation message through the capability request message. For example, the filtering information may include frequency band list information requesting capability reporting for each RAT type. For example, the filtering information may indicate whether the UE is required to report whether a specific function for each RAT type is supported. For example, the filtering information may indicate, for a specific RAT type (e.g., NR), whether the UE is required to report whether an Extended/Refined/Enhanced/Multi-Pair delay status report (DSR) proposed in the disclosure is supported. The above-described Extended/Refined/Enhanced/Multi-Pair DSR is specifically described with reference to FIG. 4 described below.

The UE may transmit a message (e.g., UECapabilityInformation) reporting its capability to the base station (operation 320). In an embodiment, a UE capability reporting message may include an indicator indicating whether the UE supports DSR reporting for data in a buffer. For example, if a DSR support field (e.g., delayStatusReport-r18) is configured to “supported” in the message, the base station may determine, identify, or consider that the UE supports DSR reporting for the data in the buffer. For example, if the DSR support field does not exist, the base station may determine, identify, or consider that the UE does not support DSR reporting for the data in the buffer. The base station may identify whether the UE supports a DSR, based on the UE capability reporting message received from the UE. If the UE supports a DSR, the base station may transmit or deliver DSR configuration information to the UE for cell group through an RRC message (e.g., an RRCReconfiguration message (at least one of operation 335 or operation 350)).

In an embodiment, the UE capability reporting message may include an indicator indicating whether the UE supports an Extended/Refined/Enhanced/Multi-Pair DSR (e.g., a function of reporting multiple remaining time and buffer size fields for each logical channel group (LCG)). For example, if a specific field (e.g., extendedDelayStatusReport/refinedDelayStatusReport/enhancedDelayStatusReport/multiPairDelayStatusReport) is configured to “supported” in the message, the base station may consider that the UE supports the Extended/Refined/Enhanced/Multi-Pair DSR. For example, if the field does not exist, the base station may consider that the UE does not support the Extended/Refined/Enhanced/Multi-Pair DSR. For example, the field may be represented by 1-bit information (e.g., 1: supported, and 0: not supported). The base station may identify whether the UE supports the Extended/Refined/Enhanced/Multi-Pair DSR, based on the UE capability reporting message received from the UE. When the UE supports the Extended/Refined/Enhanced/Multi-Pair DSR, the base station may transmit or deliver Extended/Refined/Enhanced/Multi-Pair DSR configuration information to the UE for each MAC layer device/cell group, through an RRC message (e.g., an RRCReconfiguration message (at least one of operation 335 or operation 350)).

The base station may transmit a SecurityModeCommand message to the UE in order to configure security with the UE (operation 325). In an embodiment, the base station may include a MAC-CellGroupConfig IE in the RRCReconfiguration message to configure a MAC layer device of a specific cell group of the UE. In an embodiment, MAC-CellGroupConfig may include Extended/Refined/Enhanced/Multi-Pair DSR configuration information for each logical channel (LCH)/LCG as follows.
It may include Extended/Refined/Enhanced/Multi-Pair DSR configuration information for each LCG, to be added or modified. For example, the Extended/Refined/Enhanced/Multi-Pair DSR configuration information may include one or more remaining time-related thresholds (e.g., remainingTimeThreshold) for each LCG. For example, among the one or more remaining time thresholds, one (e.g., the smallest threshold, the largest threshold, or a specific threshold specified by the base station for triggering) may be a threshold for triggering an Extended/Refined/Enhanced/Multi-Pair DSR. For example, each of the one or more thresholds may be configured in the form of an INTEGER. For example, the one or more thresholds may be configured in a specific time unit (e.g., Second/Millisecond/Microsecond/Frame/Subframe/Slot/Symbol). For example, the base station may configure the one or more thresholds in such a manner of configuring the smallest threshold or the largest threshold as a reference threshold and, for the remaining thresholds, indicating a difference, addition, or reduction time with respect to an immediately preceding or immediately succeeding threshold. For example, the base station may configure the one or more thresholds in such a manner of configuring the smallest threshold as a reference threshold and, for the remaining thresholds, indicating a multiple (e.g., an integer multiple) of the reference threshold, showing what multiple of the reference threshold each of the remaining thresholds corresponds to.

In an embodiment, the maximum number of remaining time thresholds that the base station may configure for each LCG may be predetermined and limited. In an embodiment, the one or more thresholds for each LCG may be thresholds applied when the UE triggers the Extended/Refined/Enhanced/Multi-Pair DSR. In an embodiment, the one or more thresholds for each LCG may be thresholds applied when the UE reports the Extended/Refined/Enhanced/Multi-Pair DSR.

The UE may transmit a SecurityModeComplete message to the base station (operation 330).

When a security configuration is completed, the base station may transmit an RRCReconfiguration message to the UE (operation 335). For example, the RRCReconfiguration message may include, for each cell group (e.g., at least one of an MCG or an SCG), MAC layer device configuration information (e.g., MAC-CellGroupConfig) belonging to a corresponding cell group.

When an RRC (re)configuration is completed, the UE may transmit an RRCReconfigurationComplete message to the base station (operation 340).

The UE and the base station may perform a data transmission procedure (operation 345). In this case, a general data transmission process may include three steps: RRC connection establishment, security configuration, and DRB configuration.

The base station may transmit an RRCReconfiguration message to the UE to newly configure, add, or change a configuration (operation 350).

In an embodiment of the disclosure, the base station may include a MAC-CellGroupConfig IE in the RRCReconfiguration message to configure a MAC layer device of a specific cell group of the UE.

In an embodiment of the disclosure, MAC-CellGroupConfig may include DSR configuration information for each logical channel group (LCG) as follows. The disclosure is not limited to the following example.
dsr-ConfigToAddModList-r18 (SEQUENCE (SIZE (1 . . . maxNrofLCGs-r18)) OF LCG-DSR-Config-r18): This may indicate a list of LCG-specific DSR configuration information to be added or modified.
dsr-ConfigToReleaseList-r18 (SEQUENCE (SIZE (1 . . . maxNrofLCGs-r18)) OF LCG-Id-r18): This may indicate a list of LCGs to release a DSR configuration.

In an embodiment of the disclosure, LCG-specific DSR configuration information (LCG-specific DSR configurations) may be configured as follows.
LCG-DSR-Config-r18::=SEQUENCE {
lcg-Id-r18 LCG-Id-r18,
remainingTimeThreshold-r18 INTEGER (1 . . . 64)
}
LCG-Id-r18::=INTEGER (0 . . . maxLCG-ID)

FIG. 4 illustrates a DSR MAC CE format in a wireless communication system according to an embodiment of the disclosure.

A UE may transmit a DSR MAC CE to a base station to report, for each LCG, the size of delay-critical data in a buffer and the minimum remaining time to the base station. For example, the DSR MAC CE may include the following fields. The disclosure is not limited to the following example.
LCGi 400, 401, 402, 403, 404, 405, 406, or 407: This field may indicate that there is delay information (e.g., Remaining Time and Buffer Size fields) for LCG i. For example, an LCGi field configured to 1 may indicate that delay information for LCG i is reported. An LCGi field configured to 0 may indicate that delay information for LCG i is not reported.
Remaining Time (RM) 430: This field may exist for each LCG. For example, this field may indicate a remaining time (value) of a PDCP discardTimer of a PDCP SDU having the shortest remaining time (value) of the running PDCP discardTimer among PDCP SDUs which are buffered in a corresponding LCG and have never been transmitted through a MAC PDU, based on the first symbol transmission time of initial transmission (first PUSCH transmission) of a PUSCH including the DSR MAC CE. The length of this field may be 6 bits. This field may exist only when a buffer size indicated by the corresponding Buffer Size field is not 0. Otherwise, this field may be configured to 0 as a Reserved field. If this field exists, configuring a field value to r may indicate that a range of a Remaining Time is (r, r+1] msec (e.g., greater than r msec and less than or equal to r+1 msec).
BT 410: This field may exist for each LCG. For example, this field may exist only when the corresponding LCG has additionalBSR-TableAllowed configured and a buffer size indicated by the corresponding Buffer Size field is not 0. Otherwise, this field may be configured to 0 as a Reserved field. If this field exists, a value of 1 in this field may indicate that the corresponding Buffer Size field value has been configured using Table 6.1.3.1-3 of TS 38.321. A value of 0 in this field may indicate that the corresponding Buffer Size field value has been configured using Table 6.1.3.1-2 of TS 38.321.
Buffer Size (BS) 440: This field may indicate the total size of delay-critical UL data of associated RLC and PDCP layer devices, determined by a data size calculation method of RLC and PDCP layer devices defined in Clause 5.5 (RLC) of TS 38.322 and Clause 5.15 (PDCP) of TS 38.323, after the corresponding MAC PDU is generated. For example, when the corresponding LCG has additionalBS-TableAllowed configured and the amount of delay-critical UL data of the corresponding LCG falls within a buffer size range specified in Table 6.1.3.1-3 of TS 38.321, a corresponding MAC layer device of the UE may configure a Buffer Size field by using Table 6.1.3.1-3 of TS 38.321. Otherwise, the corresponding MAC layer device may use Table 6.1.3.1-2 of TS 38.321 instead. For example, this field may be indicated in units of bytes, and the length of the field may be 8 bits.

In an embodiment of the disclosure, the DSR MAC CE may include delay information of all LCGs with pending DSRs when a MAC PDU including the DSR MAC CE is constructed.

In an embodiment of the disclosure, a Remaining Time field, a BT field, and a Buffer Size field of a specific LCG may be reported as two consecutive Octets. For example, the three fields for different LCGs may be included in the DSR MAC CE in ascending order, based on LCGi.

FIG. 4 is only an example of a structure of a DSR MAC CE, and the structure of the DSR MAC CE in the disclosure is not necessarily limited to the structure shown in FIG. 4, and may be configured in various forms including fields of the DSR MAC CE described in FIG. 4. The configuration of the DSR MAC CE described above may be applied to various embodiments of the disclosure in which the DSR MAC CE is used.

A DSR reported by the UE to the base station may indicate, for each LCG, the shortest remaining discardTimer value among PDCP SDUs buffered in each LCG. However, data reported by a Buffer Size field may have different remaining discardTimer values, rather than all having the same remaining discardTimer value. Therefore, if the base station allocates an uplink resource to a specific UE with reference to the shortest remaining discardTimer value based on the DSR reported by the UE, it may not be able to secure uplink resources for more urgent data of other UEs. The disclosure proposes a method in which a UE reports, in addition to the shortest remaining discardTimer value, multiple remaining discardTimer values and/or buffer sizes with reference to multiple remaining discardTimer thresholds configured by a base station, so that the base station receives a report on the overall buffer remaining time status from the UE and enables a more optimized uplink resource allocation scheme based on a more detailed remaining time status. In the disclosure, when the UE reports delay information of data in a buffer to the base station through a DSR, a DSR which may perform reporting by including, for each LCG, multiple Remaining Time fields and/or Buffer Size fields may be referred to as an Extended/Refined DSR. The Extended/Refined DSR is only an example of the disclosure and is not limited to the name used in the disclosure.

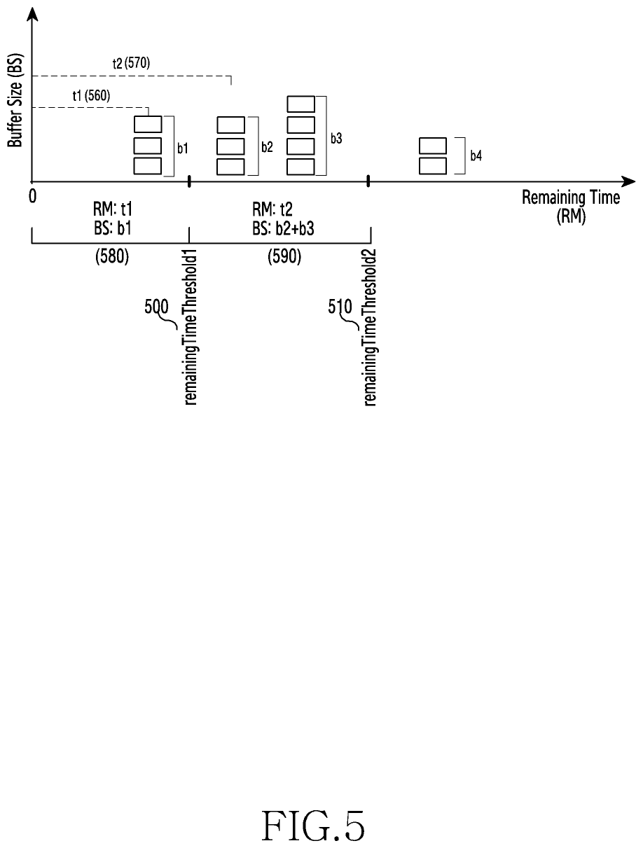

FIG. 5 illustrates an operation in which a UE reports a delay status of data in a buffer through an Extended/Refined/Enhanced/Multi-Pair DSR in a wireless communication system according to an embodiment of the disclosure.

Referring to FIG. 5, in an embodiment, when a base station configures multiple (e.g., two) remaining time thresholds for a specific LCG of a UE, the UE reports a delay status by applying the multiple thresholds to the corresponding LCG.

For example, the base station may configure remainingTimeThreshold1 500 and remainingTimeThreshold2 510 (e.g., remainingTimeThreshold1<remainingTimeThreshold2) to the corresponding LCG.

The UE may report a delay status of data of the corresponding LCG through an Extended/Refined/Enhanced/Multi-Pair DSR. The UE may report a buffer delay status to the base station through the Extended/Refined/Enhanced/Multi-Pair DSR as in the following embodiment. The disclosure is not limited to the following example.
An Extended/Refined/Enhanced/Multi-Pair DSR may include multiple Remaining Time fields for each LCG. The multiple Remaining Time fields may be Remaining Time fields respectively corresponding to multiple remaining time thresholds (remainingTimeThreshold) configured by the base station for the corresponding LCG, or to remaining time intervals between the multiple remaining time thresholds. For example, an upper bound and a lower bound of each of the remaining time intervals may be configured to two consecutive remaining time thresholds. For example, each of the remaining time intervals may include a remaining time interval in which the smallest remaining time threshold or the first remaining time threshold is configured as the upper bound (e.g., the lower bound is configured to 0). For example, the multiple Remaining Time fields may each indicate that the smallest remaining time among the remaining times (e.g., remaining discardTimer values) among PDCP SDUs buffered in the corresponding LCG falls within the respective remaining time intervals.
An Extended/Refined/Enhanced/Multi-Pair DSR may include one or more Buffer Size fields for each LCG. The one or more Buffer Size fields may be Buffer Size fields respectively corresponding to one or more remaining time thresholds (remainingTimeThreshold) configured by the base station for the corresponding LCG, or to remaining time intervals.
Each of the Remaining Time fields may indicate the shortest remaining discardTimer value, among PDCP SDUs buffered in the corresponding LCG (e.g., PDCP SDUs which have never been transmitted through a MAC PDU), whose remaining discardTimer values satisfy a corresponding remaining time threshold criterion, based on the first symbol of the first transmission of a PUSCH including a corresponding Extended/Refined/Enhanced/Multi-Pair DSR MAC CE, as a reference time. For example, each of the Remaining Time fields may exist only when the corresponding Buffer Size field is not 0. For example, a remaining time indicated by a Remaining Time field may be indicated in a specific time unit (e.g., Second/Millisecond/Microsecond/Frame/Subframe/Slot/Symbol). For example, when the corresponding field indicates r, this may mean that the remaining time falls within interval (r, r+1] (e.g., an interval greater than r and less than or equal to r+1). For example, the remaining field may be reported in a manner of indicating a remaining time/delay index corresponding to the corresponding remaining time/delay interval by referring to a predefined remaining time/delay table. For example, each of the Buffer Size fields may indicate the total size of data which satisfies the corresponding remaining time threshold criterion among data in an RLC layer device and a PDCP layer device associated with the corresponding LCG after the corresponding MAC PDU is generated. For example, when the corresponding LCG has additionalBS-TableAllowed configured and a buffer size indicated by a buffer size field falls within a buffer size range specified in Table 6.1.3.1-3 of TS 38.321, a corresponding MAC layer device of the UE may configure a corresponding Buffer Size field by using Table 6.1.3.1-3 of TS 38.321. Otherwise, the corresponding MAC layer device may use Table 6.1.3.1-2 of TS 38.321 instead. For example, the buffer size may be indicated in units of bytes, and the length of the Buffer Size field may be 8 bits. For example, a specific PDCP SDU satisfying the remaining time threshold criterion may mean the following cases. If the corresponding remaining time threshold is the smallest among one or more remaining time thresholds configured for the same LCG, and if a remaining discardTimer value of the corresponding PDCP SDU is less than or equal to the threshold, the PDCP SDU may be considered to satisfy the corresponding threshold criterion. If the corresponding remaining time threshold is not the smallest threshold among one or more remaining time thresholds configured for the same LCG, and if the remaining discardTimer value of the corresponding PDCP SDU is less than or equal to the threshold, and is greater than or equal to all other thresholds smaller than the threshold (or the largest threshold among thresholds smaller than the threshold), the PDCP SDU may be considered to satisfy the corresponding threshold criterion. For example, a specific PDCP SDU being associated with a specific remaining time interval may mean that the running remaining discardTimer value of the corresponding PDCP SDU falls within the corresponding remaining time interval (e.g., is greater than a lower bound of the corresponding interval and less than or equal to an upper bound thereof). In an embodiment, the base station may configure the remainingTimeThreshold1 500 and the remainingTimeThreshold2 510 for a specific LCG in relation to the Extended/Refined/Enhanced/Multi-Pair DSR. Further, when the remainingTimeThreshold1 500 is the smallest threshold, the UE may report the delay status through the Extended/Refined/Enhanced/Multi-Pair DSR as follows. The disclosure is not limited to the following example.
The UE may report the shortest remaining discardTimer value t1 560 among PDCP SDUs having a remaining discardTimer value less than or equal to the remainingTimeThreshold1 500, through a Remaining Time field corresponding to remainingTimeThreshold1 of the corresponding LCG or to a remaining time interval in which an upper bound thereof is remainingTimeThreshold1. The UE may report the shortest remaining discardTimer value t2 570 among PDCP SDUs having a remaining discardTimer value less than or equal to the remainingTimeThreshold2 510 and greater than or equal to the remainingTimeThreshold1 500, through a Remaining Time field corresponding to remainingTimeThreshold2 of the corresponding LCG or to a remaining time interval in which a lower bound thereof is remainingTimeThreshold1 and an upper bound thereof is remainingTimeThreshold2.
The UE may report total data size b1 580 of data of the corresponding LCG that satisfies the criterion of remainingTimeThreshold1, through a Buffer Size field corresponding to remainingTimeThreshold1 of the corresponding LCG or to a remaining time interval in which an upper bound thereof is remainingTimeThreshold1. The UE may report total data size b2+b3 590 of data of the corresponding LCG that satisfies a corresponding remaining time criterion, through a Buffer Size field corresponding to remainingTimeThreshold2 of the corresponding LCG or to a remaining time interval in which a lower bound thereof is remainingTimeThreshold1 and an upper bound thereof is remainingTimeThreshold2.

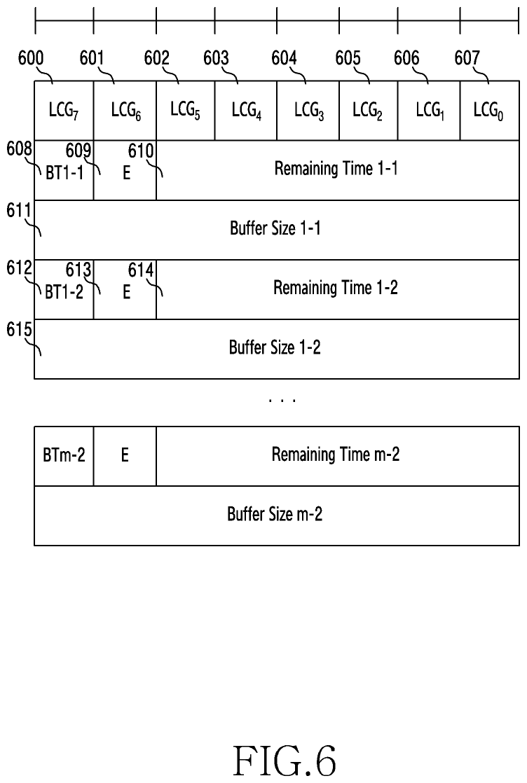

FIG. 6 illustrates an Extended/Refined/Enhanced/Multi-Pair DSR MAC CE format in a wireless communication system according to an embodiment of the disclosure.

Referring to FIG. 6, an Extended/Refined/Enhanced/Multi-Pair DSR MAC CE may include the following fields. The disclosure is not limited to the following example.
LCGi 600, 601, 602, 603, 604, 605, 606, or 607: This field may indicate that there is delay information (e.g., Remaining Time and Buffer Size fields) for LCG i. For example, an LCGi field configured to 1 may indicate that delay information for LCG i is reported. An LCGi field configured to 0 may indicate that delay information for LCG i is not reported.
Remaining Time (RM) 610 or 614: This field may exist for each LCG, for each remaining time threshold configured for a corresponding LCG or for each remaining time interval. For example, this field may indicate a remaining discardTimer time/value of a PDCP SDU having the shortest running remaining discardTimer value, which satisfies a remaining time threshold criterion or belongs to the corresponding remaining time interval, among PDCP SDUs which are buffered in the corresponding LCG and have never been transmitted through a MAC PDU, based on the first symbol transmission time of initial transmission (first PUSCH transmission) of a PUSCH including the Extended/Refined/Enhanced/Multi-Pair DSR MAC CE. For example, a remaining discardTimer time (value) of a specific PDCP SDU satisfying a specific remaining time threshold criterion may mean the following cases. If the corresponding remaining time threshold is the smallest among one or more remaining time thresholds configured for the same LCG, and if the remaining discardTimer time (value) of the corresponding PDCP SDU is less than or equal to the threshold, the remaining discardTimer time (value) of the PDCP SDU may be considered to satisfy the corresponding threshold criterion. If the corresponding remaining time threshold is not the smallest threshold among one or more remaining time thresholds configured for the same LCG, and if the remaining discardTimer value of the corresponding PDCP SDU is less than or equal to the threshold, and is greater than or equal to all other thresholds smaller than the threshold (or the largest threshold among thresholds smaller than the threshold), the remaining discardTimer time (value) of the PDCP SDU may be considered to satisfy the corresponding threshold criterion. For example, the length of a Remaining Time field may be 6 bits. For example, the Remaining Time field may exist only when a buffer size indicated by the corresponding Buffer Size field is not 0. Otherwise, the corresponding Remaining Time field may be configured to 0 as a Reserved field. If the Remaining Time field exists, configuring a field value to r may mean that a remaining time range is (r, r+1] (e.g., greater than r and less than or equal to r+1). For example, a remaining time indicated by the Remaining Time field may indicate an additional remaining time (or a difference value) compared to a remaining time indicated by the immediately preceding or first Remaining Time field belonging to the same LCG.
BT 608 or 612: This field may exist for each LCG and for each remaining time threshold configured for a corresponding LCG. For example, this field may exist only when the corresponding LCG has additionalBSR-TableAllowed configured and a buffer size indicated by the corresponding Buffer Size field is not 0. Otherwise, this field may be configured to 0 as a Reserved field. If this field exists, a value of 1 in this field may indicate that the corresponding Buffer Size field value has been configured using Table 6.1.3.1-3 of TS 38.321. A value of 0 in this field may indicate that the corresponding Buffer Size field value has been configured using Table 6.1.3.1-2 of TS 38.321.
Buffer Size (BS) 611 or 615: This field may indicate the total data size of data which satisfies the corresponding remaining time threshold criterion or belongs to the corresponding remaining time interval, among data of associated RLC and PDCP layer devices, determined by a data size calculation method of RLC and PDCP layer devices defined in Clause 5.5 (RLC) of TS 38.322 and Clause 5.15 (PDCP) of TS 38.323, after the corresponding MAC PDU is generated. For example, when the corresponding LCG has additionalBS-TableAllowed configured and a buffer size indicated by the corresponding Buffer Size field falls within a buffer size range specified in Table 6.1.3.1-3 of TS 38.321, a corresponding MAC layer device of a UE may configure a corresponding Buffer Size field by using Table 6.1.3.1-3 of TS 38.321. Otherwise, the corresponding MAC layer device may use Table 6.1.3.1-2 of TS 38.321 instead. For example, the buffer size may be indicated in units of bytes, and the length of the Buffer Size field may be 8 bits.
Extension (E) 609 or 613: This field may exist for each LCG and for each remaining time threshold configured for an LCG. This field may indicate whether an additional pair of Remaining Time and Buffer Size fields corresponding to the same LCG follows. For example, if this field is configured to 1, it may indicate that an additional pair of Remaining Time and Buffer Size fields belonging to the same LCG follows. For example, if this field is configured to 0, it may indicate that an additional pair of Remaining Time and Buffer Size fields belonging to the same LCG does not follow. If only one remaining time threshold is configured for the corresponding LCG, this field may be configured to 0 as a Reserved field.

In an embodiment, a Remaining Time field, a BT field, an Extension field, and a Buffer Size field of a specific LCG may be reported as consecutive Octets. For example, the fields for different LCGs may be included in the Extended/Refined/Enhanced/Multi-Pair DSR MAC CE in ascending order, based on LCGi.

In an embodiment, when at least one of the following conditions is satisfied, a DSR and/or an Extended/Refined/Enhanced/Multi-Pair DSR may be triggered. The disclosure is not limited to the following example.
One or more remaining time thresholds are configured for a specific LCG.
When none of packet data convergence protocol (PDCP) service data units (SDUs) buffered in the corresponding LCG or in an LCH of the LCG have been transmitted through a MAC PDU yet. Further, when, among PDCP SDUs for which data size has never been reported through a DSR or an Extended/Refined/Enhanced/Multi-Pair DSR, the smallest running PDCP discardTimer value becomes smaller than a remaining time threshold configured for the LCG, the smallest or largest threshold among remaining time thresholds, or a trigger-specific remaining time threshold.
When none of PDCP SDUs buffered in the corresponding LCG or in an LCH of the LCG have been transmitted through a MAC PDU yet. And/or, when, among PDCP SDUs for which data size has never been reported through a DSR and/or an Extended/Refined/Enhanced/Multi-Pair DSR, the smallest running PDCP discardTimer value becomes smaller than a remaining time threshold configured for the LCG or a predetermined remaining time threshold.
When none of PDCP SDUs buffered in the corresponding LCG or in an LCH of the LCG have been transmitted through a MAC PDU yet. And/or, when, among PDCP SDUs for which data size has never been reported through a DSR and/or an Extended/Refined/Enhanced/Multi-Pair DSR, the smallest running PDCP discardTimer value becomes smaller than an Extended/Refined/Enhanced/Multi-Pair DSR trigger-specific remaining time threshold configured for the LCG. For example, the Extended/Refined/Enhanced/Multi-Pair DSR trigger-specific remaining time threshold may refer to a threshold configured by a base station for the corresponding LCG in order to trigger the Extended/Refined/Enhanced/Multi-Pair DSR. For example, the trigger-specific remaining time threshold may refer to a remaining time threshold included in an existing DSR configuration.
When there is no pending DSR or Extended/Refined/Enhanced/Multi-Pair DSR in the corresponding LCG or LCH.

In an embodiment, when a PDCP SDU has not yet been transmitted through a MAC PDU and is a delay-critical PDCP SDU (as defined in TS 38.323) associated with an LCH/LCG having triggered a specific DSR, the corresponding PDCP SDU may be considered to be associated with the corresponding DSR. In an embodiment, one MAC PDU may include at most one DSR MAC CE. The DSR MAC CE may include both a DSR CE and an Extended/Refined/Enhanced/Multi-Pair DSR MAC CE. If one MAC PDU includes all PDCP SDUs associated with all pending DSRs and/or Extended/Refined/Enhanced/Multi-Pair DSRs, the corresponding MAC PDU may not include the DSR and/or the Extended/Refined/Enhanced/Multi-Pair MAC CE.

In an embodiment, after the DSR and/or the Extended/Refined/Enhanced/Multi-Pair DSR is triggered, it may be considered pending until cancelled. For example, the corresponding MAC layer device may cancel a pending DSR and/or Extended/Refined/Enhanced/Multi-Pair DSR in at least one of the following cases: when all PDCP SDUs associated with the DSR and/or the Extended/Refined/Enhanced/Multi-Pair DSR are discarded; when the corresponding MAC PDU is transmitted and includes a DSR and/or an Extended/Refined/Enhanced/Multi-Pair DSR MAC CE including delay information of all PDCP SDUs associated with the MAC PDU; or when the corresponding MAC PDU includes all PDCP SDUs associated with the DSR and/or the Extended/Refined/Enhanced/Multi-Pair DSR.

In an embodiment, the UE may include all or part of data in the following RLC/PDCP layer devices (e.g., a reporting manner of data not related to a remaining discardTimer value) in a buffer size indicated by a specific Buffer Size field (e.g., a Buffer Size field corresponding to the smallest remaining time threshold) of the corresponding LCG when the MAC layer device reports an Extended/Refined/Enhanced/Multi-Pair DSR MAC CE for the corresponding LCG. For example, all or part of the data in the following RLC/PDCP layer devices may not be included in a buffer size indicated by a Buffer Size field corresponding to a different remaining time threshold or a different remaining time interval. For another example, all or part of the data in the following RLC/PDCP layer devices may be included in buffer sizes indicated by Buffer Size fields corresponding to all thresholds or all remaining time intervals. The data in the RLC/PDCP layer devices may include at least one of the following.
RLC Data PDUs pending for retransmission (RLC AM).
When a STATUS PDU is triggered and t-StatusProhibit is not running or has expired, the estimated size of the STATUS PDU to be transmitted at the next transmission opportunity.
PDCP Control PDUs.
In the case of an AM DRB, PDCP SDUs retransmitted according to Clauses 5.1.2 and 5.13 of TS 38.323
In the case of an AM DRB, PDCP Data PDUs retransmitted according to Clause 5.5 of TS 38.323.

The delay-critical PDCP SDU of the disclosure may be defined as follows.
If pdu-SetDiscard is not configured, a PDCP SDU in which a remaining time thereof before discardTimer expiration is less than a remaining time threshold configured for the corresponding LCG (when there is one threshold) or a specific threshold (e.g., the largest threshold or the smallest threshold) among remaining time thresholds.
If pdu-SetDiscard is configured, a PDCP SDU included in a PDU Set which includes at least one PDCP SDU in which a remaining time (e.g., the time remaining until a discardTimer expires) thereof is less than a remaining time threshold (when there is one threshold) or a specific threshold (e.g., the largest threshold or the smallest threshold).

In an embodiment of the disclosure, when reporting an Extended/Refined/Enhanced/Multi-Pair DSR MAC CE, the UE may newly allocate and report, for each LCG, a Buffer Size field for the total size of data in the PDCP/RLC layer devices, for which a remaining discardTimer value is greater than a remaining time threshold configured for the corresponding LCG (when there is one threshold) or the largest remaining time threshold (when there are multiple thresholds), among PDCP/RLC data buffered in the corresponding LCG. For example, the data may be referred to as non-delay critical data. For example, when reporting non-delay critical data, the UE may report only high-importance PDUs/PDU sets, based on PDU set importance (PSI). For example, the UE may not report low-importance PDUs/PDU sets. The non-delay critical data may be reported only when the base station has activated PSI-based discard for the corresponding DRB of the corresponding UE (in the case of congestion).

In an embodiment of the disclosure, when reporting an Extended/Refined/Enhanced/Multi-Pair DSR MAC CE, the UE may report, for each LCG, a buffer size of delay-critical data buffered in the corresponding LCG, including a buffer size of low-importance data and a buffer size of high-importance data, based on PSI. For example, the UE may allocate a field (1-bit) capable of indicating PSI importance, and indicate whether the importance of data corresponding to a buffer size indicated by each Buffer Size field is high or low.

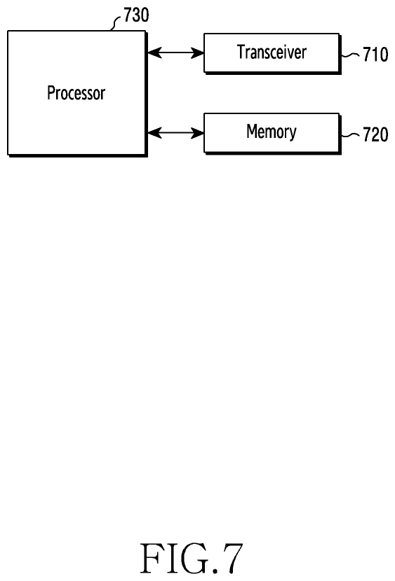

FIG. 7 is a block diagram of a UE according to an embodiment of the disclosure.

As illustrated in FIG. 7, the UE of the disclosure may include a processor 730, a transceiver 710, and a memory 720. However, components of the UE are not limited to the above-described example. For example, the UE may include a larger or smaller number of components than the above-described components. In addition, the processor 730, the transceiver 710, and the memory 720 may be implemented in the form of a single chip. According to an embodiment, the transceiver 710 of FIG. 7 may include a transmitter and a receiver. Also, the processor 730 of FIG. 7 may include a controller.

According to an embodiment, the processor 730 may control a series of processes such that the UE can operate according to the above-described embodiments of the disclosure. For example, according to an embodiment of the disclosure, the controller may control the components of the UE to perform transmission and reception methods of the UE according to whether the base station mode is a base station power saving mode or a base station normal mode. The processor 730 may include one or multiple processors, and the processor 730 may execute programs stored in the memory 720 to perform transmission and reception operations of the UE in a wireless communication system employing the above-described operations of the disclosure.

The transceiver 710 may transmit/receive signals with the base station. The signals transmitted/received with the base station may include control information and data. The transceiver 710 may include an RF transmitter configured to up-convert and amplify the frequency of transmitted signals, an RF receiver configured to low-noise-amplify received signals and down-convert the frequency thereof, and the like. However, this is only an embodiment of the transceiver 710, and the components of the transceiver 710 are not limited to the RF transmitter and the RF receiver. In addition, the transceiver 710 may receive signals through a radio channel, output the same to the processor 730, and transmit signals output from the processor 730 through the radio channel.

According to an embodiment, the memory 720 may store programs and data necessary for the operation of the UE. In addition, the memory 720 may store control information or data included in signals transmitted/received by the UE. The memory 720 may include storage media such as a read only memory (ROM), a random access memory (RAM), a hard disk, a compact disc read only memory (CD-ROM), and a digital versatile disc (DVD), or a combination of storage media. In addition, the memory 720 may include multiple memories. According to an embodiment, the memory 720 may store programs for performing transmission and reception operations of the UE according to whether the base station mode in the above-described embodiments of the disclosure is a base station power saving mode or a base station normal mode.

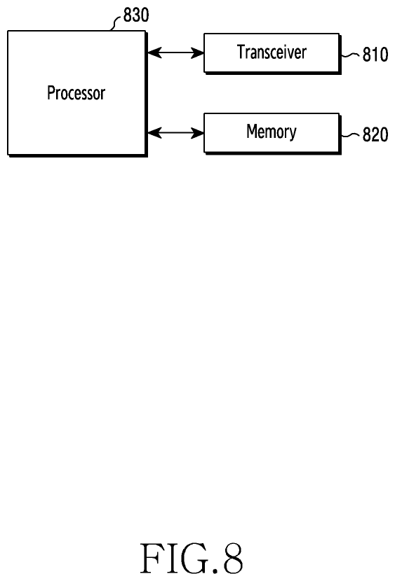

FIG. 8 is a block diagram of a base station according to an embodiment of the disclosure.

As illustrated in FIG. 8, the base station of the disclosure may include a processor 830, a transceiver 810, and a memory 820. However, components of the base station are not limited to the above-described example. For example, the base station may include a larger or smaller number of components than the above-described components. In addition, the processor 830, the transceiver 810, and the memory 820 may be implemented in the form of a single chip.

The processor 830 may control a series of processes such that the base station can operate according to the above-described embodiments of the disclosure. For example, according to an embodiment of the disclosure, the controller 830 may control the components of the base station to perform UE scheduling methods according to whether the base station mode is a base station power saving mode or a base station normal mode. The processor 830 may include one or multiple processors, and the processor 830 may execute programs stored in the memory 820 to perform transmission and reception operations of the UE in a wireless communication system employing the above-described operations of the disclosure.

The transceiver 810 may transmit/receive signals with the UE. The signals transmitted/received with the UE may include control information and data. The transceiver 810 may include an RF transmitter configured to up-convert and amplify the frequency of transmitted signals, an RF receiver configured to low-noise-amplify received signals and down-convert the frequency thereof, and the like. However, this is only an embodiment of the transceiver 810, and the components of the transceiver 810 are not limited to the RF transmitter and the RF receiver. In addition, the transceiver 810 may receive signals through a radio channel, output the same to the processor 830, and transmit signals output from the processor 830 through the radio channel.

According to an embodiment, the memory 820 may store programs and data necessary for operations of the base station. In addition, the memory 820 may store control information or data included in signals transmitted/received by the base station. The memory 820 may include storage media such as a ROM, a RAM, a hard disk, a CD-ROM, and a DVD, or a combination of storage media. In addition, the memory 820 may include multiple memories. Furthermore, according to an embodiment, the memory 820 may store programs for performing the above-described methods according to embodiments of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
transmitting, to a base station, first information indicating that the terminal supports a delay status report (DSR) of a buffered data;
receiving, from the base station, configuration information on a plurality of remaining time thresholds per logical channel group (LCG); and
transmitting, to the base station, second information including a remaining time field indicating the shortest remaining time among packet data convergence protocol (PDCP) service data units (SDUs) associated with a corresponding remaining time threshold of an LCG.

2. The method of claim 1, wherein the shortest remaining time is based on time of a first symbol of a first physical uplink shared channel (PUSCH) transmission including a medium access control (MAC) control element (CE) associated with the DSR.

3. The method of claim 1,
wherein the second information further includes at least one field per LCG, and
wherein the at least one field include at least one of a buffer size field, a BT field, or an extension field.

4. The method of claim 1,
wherein a buffer size includes a PDCP control protocol data unit (PDU), a retransmitted PDCP SDU or PDCP data PDU for acknowledged mode (AM) data radio bearer (DRB), a radio link control (RLC) data PDU associated with a RLC AM, or an estimated size of a status PDU, and
wherein the buffer size is indicated by a buffer size field corresponding to a first remaining time threshold.

5. The method of claim 3,
wherein the remaining time field includes 6 bits, and
wherein the extension field indicates an additional pair of the remaining time field and the buffer size field corresponding a later remaining time threshold.

6. A method performed by a base station in a wireless communication system, the method comprising:
receiving, from a terminal, first information indicating that the terminal supports a delay status report (DSR) of a buffered data;
transmitting, to the terminal, configuration information on a plurality of remaining time thresholds per logical channel group (LCG); and
receiving, from a terminal, second information including a remaining time field indicating the shortest remaining time among packet data convergence protocol (PDCP) service data units (SDUs) associated with a corresponding remaining time threshold of an LCG.

7. The method of claim 6, wherein the shortest remaining time is based on time of a first symbol of a first physical uplink shared channel (PUSCH) transmission including a medium access control (MAC) control element (CE) associated with the DSR.

8. The method of claim 6,
wherein the second information further includes at least one field per LCG, and
wherein the at least one field include at least one of a buffer size field, a BT field, or an extension field.

9. The method of claim 6,
wherein a buffer size includes a PDCP control protocol data unit (PDU), a retransmitted PDCP SDU or PDCP data PDU for acknowledged mode (AM) data radio bearer (DRB), a radio link control (RLC) data PDU associated with a RLC AM, or an estimated size of a status PDU, and
wherein the buffer size is indicated by a buffer size field corresponding to a first remaining time threshold.

10. The method of claim 8,
wherein the remaining time field includes 6 bits, and
wherein the extension field indicates an additional pair of the remaining time field and the buffer size field corresponding a later remaining time threshold.

11. A terminal comprising:
at least one transceiver;
at least one processor communicatively coupled to the at least one transceiver; and
at least one memory, communicatively coupled to the at least one processor, storing instructions executable by the at least one processor individually or in any combination to cause the terminal to:
transmit, to a base station, first information indicating that the terminal supports a delay status report (DSR) of a buffered data,
receive, from the base station, configuration information on a plurality of remaining time thresholds per logical channel group (LCG), and
transmit, to the base station, second information including a remaining time field indicating the shortest remaining time among packet data convergence protocol (PDCP) service data units (SDUs) associated with a corresponding remaining time threshold of an LCG.

12. The terminal of claim 11, wherein the shortest remaining time is based on time of a first symbol of a first physical uplink shared channel (PUSCH) transmission including a medium access control (MAC) control element (CE) associated with the DSR.

13. The terminal of claim 11,
wherein the second information further includes at least one field per LCG, and
wherein the at least one field include at least one of a buffer size field, a BT field, or an extension field.

14. The terminal of claim 11,
wherein a buffer size includes a PDCP control protocol data unit (PDU), a retransmitted PDCP SDU or PDCP data PDU for acknowledged mode (AM) data radio bearer (DRB), a radio link control (RLC) data PDU associated with a RLC AM, or an estimated size of a status PDU, and
wherein the buffer size is indicated by a buffer size field corresponding to a first remaining time threshold.

15. The terminal of claim 13,
wherein the remaining time field includes 6 bits, and
wherein the extension field indicates an additional pair of the remaining time field and the buffer size field corresponding a later remaining time threshold.

16. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
receive, from a terminal, first information indicating that the terminal supports a delay status report (DSR) of a buffered data,
transmit, to the terminal, configuration information on a plurality of remaining time thresholds per logical channel group (LCG), and
receive, from a terminal, second information including a remaining time field indicating the shortest remaining time among packet data convergence protocol (PDCP) service data units (SDUs) associated with a corresponding remaining time threshold of an LCG.

17. The base station of claim 16, wherein the shortest remaining time is based on time of a first symbol of a first physical uplink shared channel (PUSCH) transmission including a medium access control (MAC) control element (CE) associated with the DSR.

18. The base station of claim 16,
wherein the second information further includes at least one field per LCG, and
wherein the at least one field include at least one of a buffer size field, a BT field, or an extension field.

19. The base station of claim 16,
wherein a buffer size includes a PDCP control protocol data unit (PDU), a retransmitted PDCP SDU or PDCP data PDU for acknowledged mode (AM) data radio bearer (DRB), a radio link control (RLC) data PDU associated with a RLC AM, or an estimated size of a status PDU, and
wherein the buffer size is indicated by a buffer size field corresponding to a first remaining time threshold.

20. The base station of claim 18,
wherein the remaining time field includes 6 bits, and
wherein the extension field indicates an additional pair of the remaining time field and the buffer size field corresponding a later remaining time threshold.
